(19) United States
(12) Patent Application Publication
(10) Pub. No.: US 2015/0102588 A1
(43) Pub. Date: Apr. 16, 2015

(54) NON-SLITTED TEAR SEAM FOR MINI-WRAPPERS

(71) Applicant: Autoliv ASP, Inc., Ogden, UT (US)

(72) Inventor: Blake L. Cheal, Pleasant View, UT (US)

(73) Assignee: Autoliv ASP, Inc., Ogden, UT (US)

(21) Appl. No.: 14/052,884

(22) Filed: Oct. 14, 2013

(51) Int. Cl. B60R 21/201

(52) U.S. Cl. CPC B60R 21/201
USPC 280/728.2; 29/428

(57) ABSTRACT

An airbag assembly may include an inflatable airbag with a stowed configuration and a deployed configuration, and a restraint member that keeps the inflatable airbag in the stowed configuration. The restraint member may have a frangible portion designed to tear at a pre-established threshold level of tension to permit deployment of the inflatable airbag. The frangible portion may have material that has been pre-stressed such that it has a lower strength than surrounding material. In one example, pre-stressing may be carried out by forming a crease in the frangible portion and, optionally, subjecting the frangible portion to compressive stress. When the airbag deploys, the frangible portion may predictably tear to release the airbag. The airbag assembly may be an inflatable curtain airbag, and the restraint member may one of a plurality of wrappers distributed along the length of the inflatable curtain airbag to encircle it in the stowed configuration.

### TECHNICAL FIELD

The present invention relates to automotive safety. More specifically, the present invention relates to an inflatable airbag curtain and method of folding to facilitate more accurate and efficient deployment of the airbag curtain into the interior of a vehicle.

### BACKGROUND

Inflatable safety restraint devices, or airbags, are mandatory on most new vehicles. Airbags are typically installed as part of a system with an airbag module in the steering wheel on the driver's side of car and in the dashboard on the passenger side of a car. In the event of an accident, a sensor within the vehicle measures abnormal deceleration and triggers the ignition of a charge contained within an inflator. Expanding gases from the charge travel through conduits and fill the airbags, which immediately inflate in front of the driver and passenger to protect them from harmful impact with the interior of the car. Airbag systems have also been developed in response to the need for similar protection from lateral impacts between a passenger and the side of a vehicle's interior. This might occur when another vehicle collides with the side of the car, or in a rollover situation where the side of car is repeatedly impacting the ground.

It is desirable to make airbags of all types compact when stowed, and yet able to inflate reliably into the desired protective position. It is also desirable to make airbags less expensive and easier to produce. It is further desirable to make airbags easier to install in vehicles.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1A is a side elevation view of one embodiment of an airbag assembly, wherein the airbag assembly comprises a mounting assembly that is coupled to an inflatable curtain airbag, wherein the mounting assembly is configured to retain the airbag in a stowed configuration within the interior of a vehicle;

FIG. 1B is side elevation view of the airbag assembly of FIG. 1A, wherein the inflatable curtain airbag is in a deployed configuration;

FIG. 2 is an exploded perspective view of the airbag assembly of FIG. 1A, wherein the airbag has been partially cutaway;

FIG. 3A is a cutaway perspective view of the airbag assembly of FIG. 1A, wherein the airbag has been rolled, but has not yet been wrapped;

FIG. 3B is a cutaway perspective view of the airbag assembly of FIG. 3A, wherein a wrapper of the mounting assembly is being wrapped around the airbag;

FIG. 4 is another cutaway perspective view of the airbag assembly of FIG. 3B, after the airbag has been wrapped by the wrapper;

FIG. 5A is a cross-sectional view of the airbag assembly of FIG. 1A before the airbag has been rolled and wrapped;

FIG. 5B is a cross-sectional view of the airbag assembly of FIG. 5A after the airbag has been rolled and wrapped;

FIG. 6 is a front elevation view of another embodiment of a wrapper for an airbag mounting assembly;

FIG. 7 is a front elevation view of another embodiment of a wrapper for an airbag mounting assembly;

FIG. 8 is a cross-sectional view of the wrapper for an airbag mounting assembly of FIG. 7 as secured around the airbag;

FIG. 9 is a front elevation view of another embodiment of a wrapper for an airbag mounting assembly, in which the frangible portion has a crease;

FIG. 10 is a side elevation view of the wrapper of FIG. 9, with a crease formed in the wrapper by an initial folding stage;

FIG. 11 is a side elevation view of the wrapper of FIG. 9, with the crease further defined by a secondary folding stage;

FIG. 12 is side elevation view of the wrapper of FIG. 9, with the wrapper laid flat such that the crease is unfolded;

FIG. 13 is a side elevation view of a wrapper of an airbag mounting assembly according to another alternative embodiment of the invention, wherein the wrapper has a thin section in which the material has been pre-stressed; and

FIG. 14 is a side elevation view of the wrapper of FIG. 13 as compression is applied to form the thin section.

### DETAILED DESCRIPTION

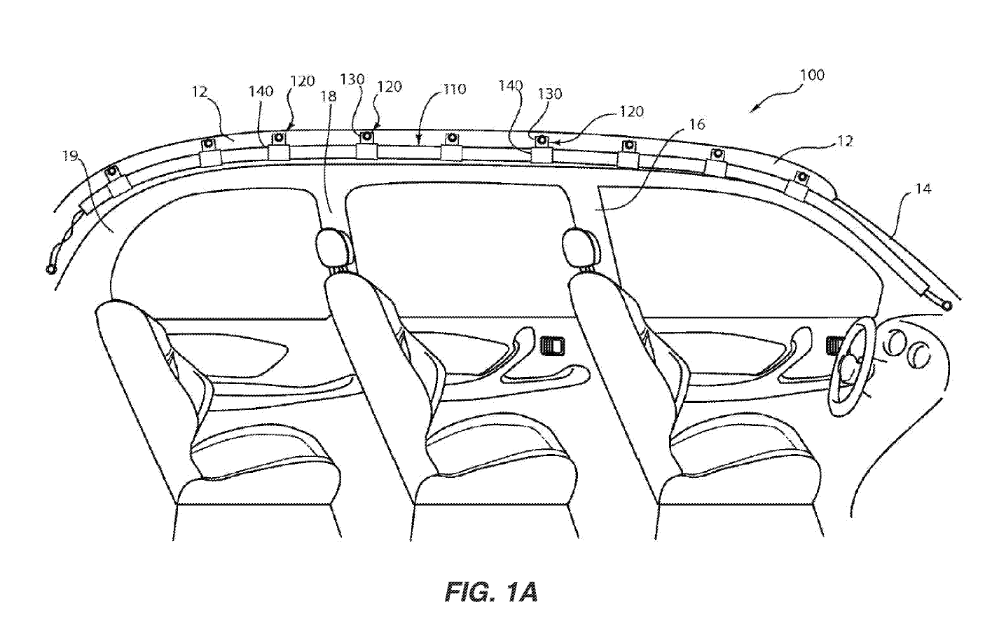

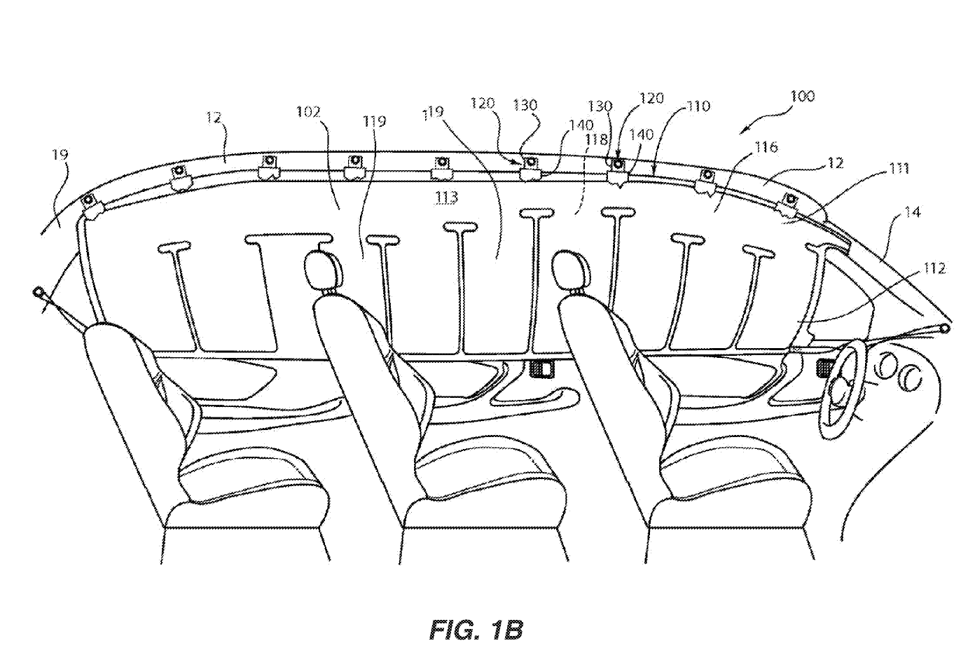

The presently preferred embodiments of the present invention will be best understood by reference to the drawings, wherein like parts are designated by like numerals throughout. It will be readily understood that the components of the present invention, as generally described and illustrated in the Figures herein, could be arranged and designed in a wide variety of different configurations. Thus, the following more detailed description of the embodiments of the apparatus, system, and method of the present invention, as represented in FIGS. 1 through 14, is not intended to limit the scope of the invention, as claimed, but is merely representative of presently preferred embodiments of the invention.

The phrases “connected to,” “coupled to” and “in communication with” refer to any form of interaction between two or more entities, including mechanical, electrical, magnetic, electromagnetic, fluid, and thermal interaction. Two components may be coupled to each other even though they are not in direct contact with each other. The term “abutting” refers to items that are in direct physical contact with each other, although the items may not necessarily be attached together. The phrase “fluid communication” refers to two features that are connected such that a fluid within one feature is able to pass into the other feature.

The term “tear” refers to the process by which an object breaks into two pieces in response to force pulling the pieces apart. “Tearing” does not refer to any particular failure mode or tear propagation pattern, but is broadly used to encompass the many failure modes that can cause one object to break into two. The term “strength,” as a material property, relates to the ability of a material to withstand any type of stress to which the material may be subjected, including tensile, compressive, and shear stresses. A material that has lower strength than surrounding material has a lower ability to withstand tension, compression, or shear, and therefore will exhibit plastic deformation or failure at a relatively lower level of tensile, compressive, or shear stress.

The term “perforated” refers to the presence of a plurality of relatively small holes in a piece of material. The holes may or may not be distributed along a relatively even pattern. A region of a part that is “more perforated” than surrounding regions is a region in which there are more holes, or larger holes, than in the surrounding portion. A woven material such as a fabric may be said to be “perforated” due to the presence of voids between interwoven strands of material; if holes are formed in a region of the fabric (beyond those inherently present in the fabric itself), the region will be relatively “more perforated” than surrounding regions.

Inflatable airbag systems are widely used to minimize occupant injury in a collision scenario. Airbag modules have been installed at various locations within a vehicle, including, but not limited to, the steering wheel, the instrument panel, within the side doors or side seats, adjacent to the roof rail of the vehicle, in an overhead position, or at the knee or leg position. In the following disclosure, “airbag” may refer to an inflatable curtain airbag 110, overhead airbag, front airbag, or any other airbag type.

The inflatable curtain airbag 110 may be used to protect the occupants of a vehicle during a side collision or roll-over collision. The inflatable curtain airbag 110 may extend longitudinally within the vehicle and may be coupled to or next to the roof rail of the vehicle. The inflatable curtain airbag 110 may expand in a collision scenario along the side of the vehicle between the vehicle occupants and the side structure of the vehicle. In a deployed state, an inflatable curtain airbag 110 may cover at least a portion of side vehicle structure that includes side windows and a B-pillar of the vehicle. In some embodiments, inflatable curtain airbag 110 may extend from an A-pillar to a C-pillar of the vehicle. In other embodiments, inflatable curtain airbag 110 may extend from the A-pillar to a D-pillar of the vehicle.

The inflatable curtain airbag 110 may be installed adjacent the roof rail of a vehicle in an undeployed state, in which the inflatable curtain airbag 110 is rolled or folded or a combination thereof and retained in the folded or rolled configuration by being wrapped at certain points along the airbag. In this state, the inflatable airbag may be said to be in a stowed configuration. When deployed, the inflatable curtain airbag 110 exits the stowed configuration and assumes an extended shape. The extended and inflated airbag 110 may be said to be in a deployed configuration. Thus, an airbag mounting apparatus typically allows for a secure connection between the vehicle and the airbag, yet allows the airbag to change configurations from the stowed configuration to the deployed configuration.

FIG. 1A depicts airbag assembly 100 from a perspective view, wherein a mounting assembly 120 is coupled to an inflatable curtain airbag 110 that is in a stowed configuration, and is mounted adjacent a roof rail 12 of a vehicle. Airbag assembly 100 may comprise an inflatable curtain airbag 110, and an airbag mounting assembly 120. A plurality of mounting assemblies 120 may be employed to couple curtain airbag 110 to a vehicle. Mounting assembly 120 may comprise a mounting member 130 and a restraint member, which may take the form of a wrapper 140. In alternative embodiments, a “restraint member” may be any structure or feature that helps an airbag to remain in a stowed configuration; thus, a “restraint member” need not be a wrapper as shown, but may instead be an envelope, a tether, a sleeve, or any other structure known in the automotive safety arts for keeping an airbag stowed.

The mounting assembly 120 may be employed to couple inflatable curtain airbag 110 adjacent a vehicle roof rail 12, or other vehicle structure. Airbag assembly 100 may further comprise an inflator 104, which may be connected to the inflatable curtain airbag 110 via a fill tube 106. In the depicted embodiment, inflatable curtain airbag 110 extends from an A-pillar 14 to a D-pillar 19. Inflatable curtain airbag 110 also extends past a B-pillar 16 and a C-pillar 18 such that in a deployed configuration, the inflatable curtain airbag at least partially covers the B- and C-pillars, as depicted in FIG. 1B.

FIG. 1B is a perspective view of inflatable curtain airbag assembly 100, wherein the airbag is depicted in a deployed configuration. Inflatable curtain airbag 110 is configured to become inflated upon activation of the inflator 104 and/or other optional inflators such that the airbag transitions from the stowed configuration to the deployed configuration. During deployment, wrapper 140 is configured to tear such that inflatable curtain airbag 110 can adopt the deployed configuration. In the deployed and in an extended configuration, such as before rolling and/or folding, inflatable curtain airbag 110 may be described as having an upper portion 111, a lower portion 112, a front face 113, and a rear face (not visible). The various faces of inflatable curtain airbag 110 define an interior chamber 118, which is in fluid communication with the inflator 104 via the fill tube 106. The interior chamber 118 may be divided into inflation cells 119 via stitching. The various faces of inflatable curtain airbag 110 may comprise panels of a woven nylon fabric that are coupled together at a seam to form the interior chamber 118.

Upper portion 111 of inflatable curtain airbag 110 is the portion of the airbag that is closest to the headliner of a vehicle when the airbag is in a deployed state. Lower portion 112 is below upper portion 111 when inflatable curtain airbag 110 is in a deployed state, and is closest to a floor of the vehicle. The term “lower portion” is not necessarily limited to the portion of inflatable curtain airbag 110 that is below a horizontal medial plane of the inflatable curtain airbag, but may include less than half, more than half or exactly half of the bottom portion of the inflatable curtain airbag. Likewise, the term “upper portion” is not necessarily limited to the portion of inflatable curtain airbag 110 that is above a horizontal medial plane of the airbag, but may include less than half, more than half or exactly half of the top portion of the airbag.

Upon activation, the inflator 104 rapidly generates and/or releases inflation gas, which rapidly inflates the inflatable curtain airbag 110. The inflator 104 may be one of several types, such as pyrotechnic, stored gas, or a combination inflator and may comprise a single or multistage inflator. The inflator 104 may be stored at any suitable location relative to the inflatable curtain airbag 110. As the inflatable curtain airbag 110 becomes inflated, tension is applied to the wrapper 140, which causes the wrapper 140 to tear, and therefore, cease to retain the inflatable curtain airbag 110 in the stowed configuration.

As will be appreciated by those skilled in the art, a variety of types and configurations of airbag inflatable curtain airbags can be utilized without departing from the scope and spirit of the present disclosure. For example, the size, shape, and proportions of the inflatable curtain airbag may vary according to its use in different vehicles or different locations within a vehicle. Also, the inflatable curtain airbag may comprise one or more of any materials well known in the art, such as a woven nylon fabric. Additionally, the airbag inflatable curtain airbag may be manufactured using a variety of techniques such as one piece weaving, cut and sew, or a combination of the two techniques. Further, the inflatable curtain airbag may be manufactured using sealed or unsealed seams, wherein the seams are formed by stitching, adhesive, taping, radio frequency welding, heat sealing, or any other suitable technique or combination of techniques.

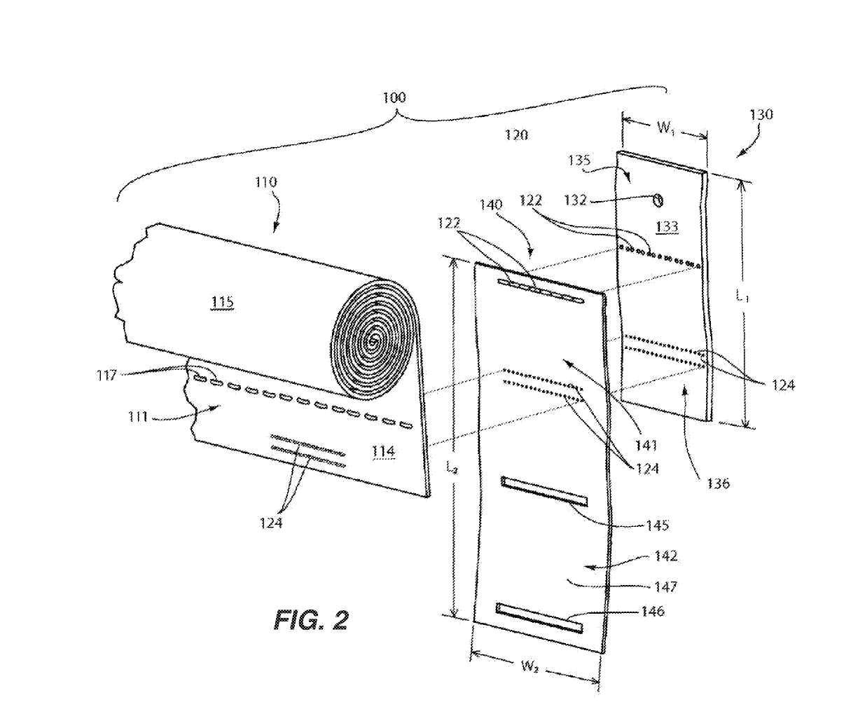

FIG. 2 depicts the airbag assembly 100 from an exploded perspective view in which inflatable curtain airbag 110 is partially cut away. Each mounting assembly 120 may comprise a mounting member 130 and a wrapper 140. The mounting member 130 may comprise a flexible fabric, such as a woven nylon material. In one embodiment, the mounting member 130 may comprise a nylon monofilament such as seat belt webbing. The mounting member 130 may comprise more than one layer of fabric. In the depicted embodiment, the mounting member 130 comprises a rectangular piece of seat belt webbing. The mounting member 130 may have a mounting aperture 132, a front side 133, a rear side (not visible), a top portion 135, and a bottom portion 136. The mounting aperture 132 is located on the top portion 135. The mounting aperture 132 is configured to receive a fastener, such as a screw, bolt, snap fitting, clip, or a mounting feature coupled to the vehicle that protrudes through the mounting aperture 132. Top and bottom portions 135 and 136 refer to an approximate upper half and lower half, respectively, when mounting member 130 is in the same orientation as depicted in FIG. 2.

By way of example, and not of limitation, the mounting member 130 may comprise a width W₁ that is within a range of from about 40 mm to about 80 mm, and a length L₁ that is within a range of from about 80 mm to about 150 mm. A center of the mounting aperture 132 is located within a range of from about 20 mm to about 30 mm from a top edge of top portion 135. One skilled in the art will recognize that the width and length of the mounting member 130 may be varied for use with different vehicles, wrappers, or airbags. In the depicted embodiment, W₁ is 48 mm, L₁ is 100 mm, the mounting aperture 132 is 25 mm from the top edge of top portion 135, and the stitching 122 is 40 mm from the top edge of top portion 135.

One skilled in the art will also recognize that a variety of types of fabrics may be used to form the mounting member without departing from the spirit of this disclosure. In another embodiment, the mounting member may comprise any one of a variety of materials, such as a thermoplastic material, a thermosetting material, or any other polymer. Likewise, the mounting member may comprise a variety of shapes. For example, the mounting member may be square, triangular, round, trapezoidal, or pentagonal. Further, the mounting member may comprise more or fewer apertures than described herein. For example, in one embodiment, the mounting member comprises two mounting apertures, and in another embodiment, the mounting member comprises three mounting apertures. Further, the location and/or shape of the apertures may vary from the depiction of FIG. 2.

The wrapper 140 may comprise a rectangular piece of flexible material, such as a non-woven nylon, polypropylene, or a plastic film. The wrapper 140 has a first segment 141 and a second segment 142. The first segment 141 is configured such that it can be attached to the mounting member 130 via stitching 122. The second segment 142 has a first opening 145 and a second opening 146, which are each configured as an elongated slot. The openings 145 and 146 may each comprise a cutout portion of wrapper 140, or a slit cut into the wrapper. The first and second openings 145 and 146 are each configured to receive, or slide over, the mounting member 130 and thereby retain the airbag assembly 100 in the stowed configuration. As such, a length of wrapper 140 and a width of each of the openings 145 and 146 are of predetermined magnitudes and may vary according to their use with different airbags. Generally, the length of the first and second openings 145 and 146 may each be about the same as the width of mounting member 130 (W₁). The wrapper 140 also comprises a portion 147 that is located between first and second openings 145 and 146.

As noted herein, wrapper 140 is configured to fail during airbag 110 deployment. The wrapper 140 may comprise a material that is generally weak enough to tear at any point during deployment. When deployed from the stowed configuration, wrapper 140 is most likely to tear at the first opening 145. As such, when curtain airbag 110 is packaged in a predetermined manner, predetermined deployment characteristics such as trajectory and speed can be consistently achieved. The wrapper 140 may be configured to be completely severed such that after deployment of the inflatable curtain airbag 110, the wrapper 140 comprises two separate pieces of material. In another embodiment, the wrapper may comprise a predetermined tear zone, or “frangible portion,” that may be defined by perforations, tear stitching, or a portion of the wrapper that is weakened in some manner.

The mounting member 130 and wrapper 140 may be attached together independently of the inflatable curtain airbag 110. When coupled together, a mounting member 130 and wrapper 140 may define a mounting assembly 120. The coupled mounting member 130 and wrapping member 140 may also be called a sub-assembly of an airbag assembly 100. The mounting assembly 120 may be attached to an airbag cushion via stitching 124, which may extend through the airbag cushion 110, wrapper 140, and mounting member 130. As such, stitching 122, which is employed to attach mounting member 130 to wrapper 140, may comprise a tack stitch.

By way of example, and not of limitation, a width W₂ of the wrapper 140 may be between about 60 mm and about 100 mm, a length L₂ may be between about 145 mm and about 175 mm, stitching 122 may be between about 3 mm and about 10 mm from a top edge of first segment 141, a center of first opening 145 may be located between about 85 mm and about 105 mm from the top edge of the first segment 141, and a center of second opening 146 may be located between about 135 mm and about 155 mm from the top edge of the first segment 141. In the depicted embodiment, W₂ of wrapper 140 is 75 mm, L₂ is 160 mm, stitching 122 is located 5 mm from the top edge of first segment 141, first opening 145 is 95 mm from the top edge of the first segment 141, second opening 146 is 148 mm from the top edge of the first segment 141, and a width of each of the first and second openings is 48 mm.

For clarity, the inflatable curtain airbag 110 is cutaway in FIG. 2. The inflatable curtain airbag 110 has been manipulated into a rolled configuration and oriented such that top portion 111 is turned downward, and rear face 114 is facing forward. In the rolled configuration, airbag 110 has an outer surface 115, which may be defined by the front face 113 of the inflatable curtain airbag 110. The top portion 111 of the inflatable curtain airbag 110 may be coupled to the mounting assembly 120 at the first segment 141 of the wrapper 140. The inflatable curtain airbag 110 may be coupled to the mounting assembly 120 at a non-inflatable portion, such as an area outside of seam 117. As noted above, the inflatable curtain airbag 110 may be coupled to the mounting assembly 120 via stitching 124, which protrudes through the wrapper 140 and the mounting member 130. If the mounting member 130 and the wrapper 140 are not attached together as a sub-assembly before being coupled to the inflatable curtain airbag 110, the airbag assembly 100 may not comprise both stitching 122 and 124, but rather may only comprise one set of stitching that couples together the airbag 110, the wrapping member 140, and the mounting member 130.

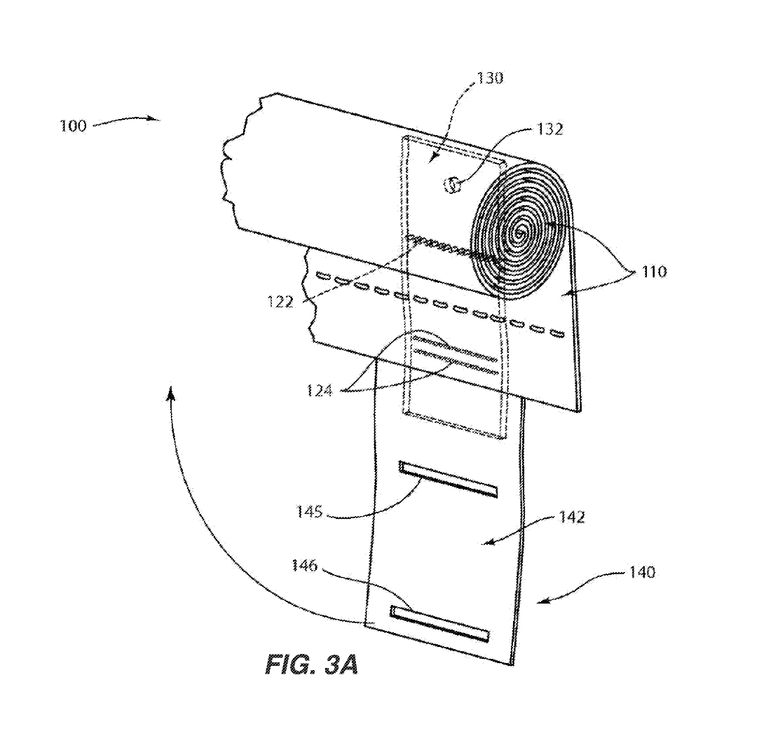

FIGS. 3A-B depict the airbag assembly 100 being manipulated into the stowed configuration, starting at a point after airbag 110 has been coupled to the mounting member 130 and the wrapper 140. Collectively, FIGS. 2-4, and their associated text, may be said to comprise a method for manufacturing an inflatable curtain airbag assembly, a method for manufacturing a mounting assembly, a method for packing an inflatable curtain airbag, a method for coupling an inflatable curtain airbag to a vehicle, and any combination of the preceding methods.

FIG. 3A is a perspective view of the airbag assembly 100, wherein the inflatable curtain airbag 110 has been partially cutaway. The rolled inflatable curtain airbag 110, mounting member 130 and wrapper 140 are coupled together via stitching 122 and 124. As depicted in the view of FIG. 3A, the inflatable curtain airbag 110 is most forward, the mounting member 130 is most rearward, and the wrapper 140 is sandwiched between them. These components are assembled in a predetermined orientation such that second segment 142 of wrapper 140, with first and second openings 145 and 146, extends beyond mounting member 130 and airbag 110, such that the second segment 142 can be moved away from the mounting member 130 in the direction of the inflatable airbag 110 as shown by the arrow. The wrapper 140 may continue to be wrapped around outer surface 115 of airbag 110 until the first opening 145 is adjacent to the top portion of the mounting member 130.

FIG. 3B is a cutaway perspective view of the airbag assembly 100 of FIG. 3A after the first segment 141 of the wrapper 140 has been wrapped around the outer surface 115 of the inflatable curtain airbag 110. As shown, the wrapper 140 is being coupled to the mounting member 130. The second segment 142 of the wrapper 140 may continue to be directed toward the top portion 135 of mounting member 130 until first opening 145 is adjacent to, and aligned with, the top portion 135 of the mounting member 130. The first opening 145 may be slid over top portion 135 such that first opening 145 receives top portion 135 and such that second opening 146 of wrapper 140 is located on the rear-face side of mounting member 130. The second segment 142 may then be pushed down toward the inflatable curtain airbag 110 and the first segment 141. The second segment 142 and specifically, the second opening 146 may continue to be wrapped toward the back face of mounting member 130 in the direction of bottom portion 136, such that portion 147, which is located between openings 145 and 146, is adjacent to the rear face of the mounting member 130.

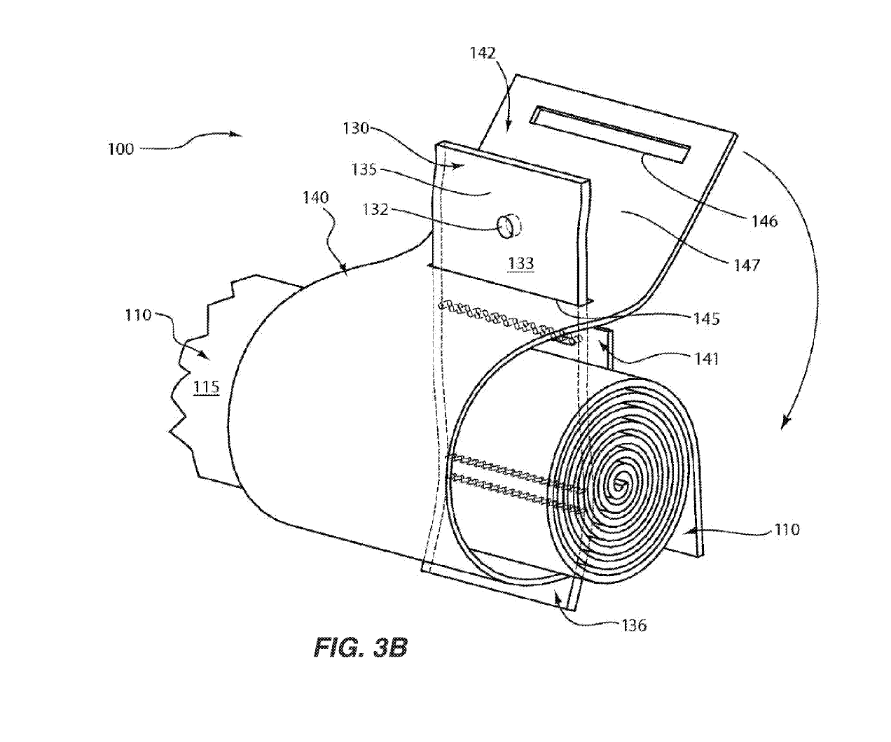

FIG. 4 is another cutaway perspective view of airbag assembly 100 of FIG. 3B after the inflatable curtain airbag 110 has been wrapped and retained in the stowed configuration. The view of FIG. 4 is from a lower perspective than FIGS. 3A-B so that relationships between the mounting member 130 and the wrapper 140 are visible. The second opening 146 of the wrapper 140 has been slid over bottom portion 136 of the mounting member 130 such that the second opening 146 has received the bottom portion 136 and the second segment 142 of the wrapper 140 is retained on the mounting member 130. The second segment 142 of the wrapper 140 partially overlaps the first segment 141, but is generally separated from the first segment 141 by the mounting member 130. In the depicted embodiment, the bottom portion 136 of the mounting member 130 has squared corners with right angles and no features to aid the retention of the second segment 142 of wrapper 140 on the bottom portion 136 of the mounting member 130; however in another embodiment, the bottom portion 142 of the wrapping member 140 may comprise features to aid in the retention of the wrapper 140. For example, in one embodiment, the sides of the bottom portion 136 of the mounting member 130 comprise indentations such as slots into which the second opening 146 of the wrapper 140 can fit and thereby be retained.

The wrapper 140 retains the inflatable curtain airbag 110 by circumnavigating the rolled inflatable curtain airbag 110 such that the wrapper 140 abuts the outer surface 115. The length of the wrapper 140 may determine the circumference of the rolled inflatable curtain airbag 110, or alternatively, the circumference of the rolled inflatable curtain airbag 110 may determine the length of the wrapper 140. The wrapper 140 may fit snugly around the inflatable curtain airbag 110 such that the wrapper 140 applies a squeezing pressure to the inflatable curtain airbag 110. The mounting member 130 is depicted as having a bolt 126 projecting into and through the mounting aperture 132, which is located on top portion 135 of the mounting member 130. When mounted in a vehicle, gravity may tend to exert a downward force on the airbag assembly 100; however, because the wrapper 140 is coupled to the mounting member 130 via the two wrapper openings 145, 146, the wrapper 140 may not tend to tighten or “creep” on the inflatable curtain airbag 110.

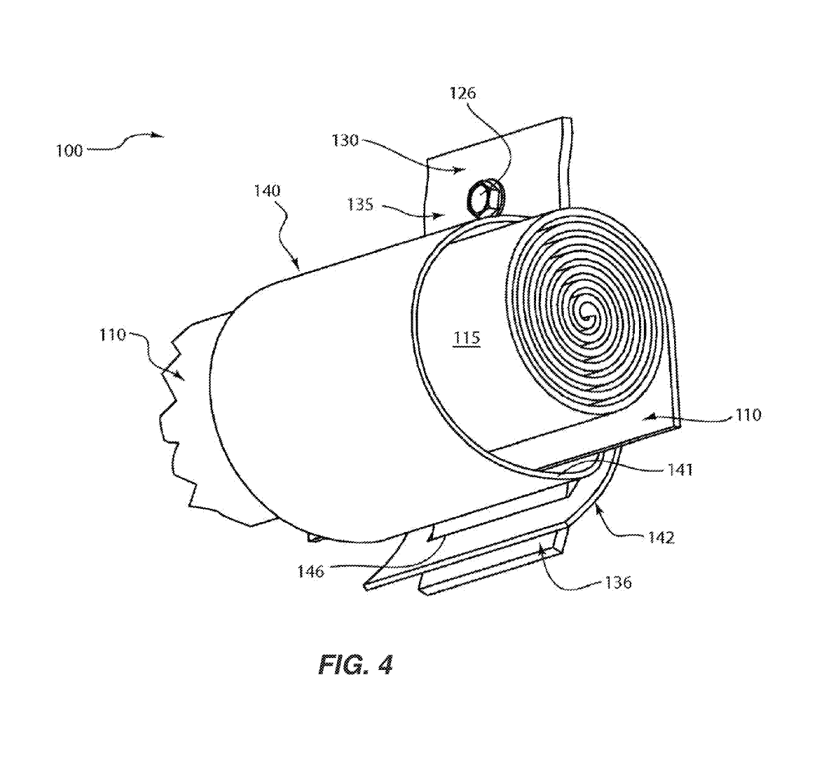

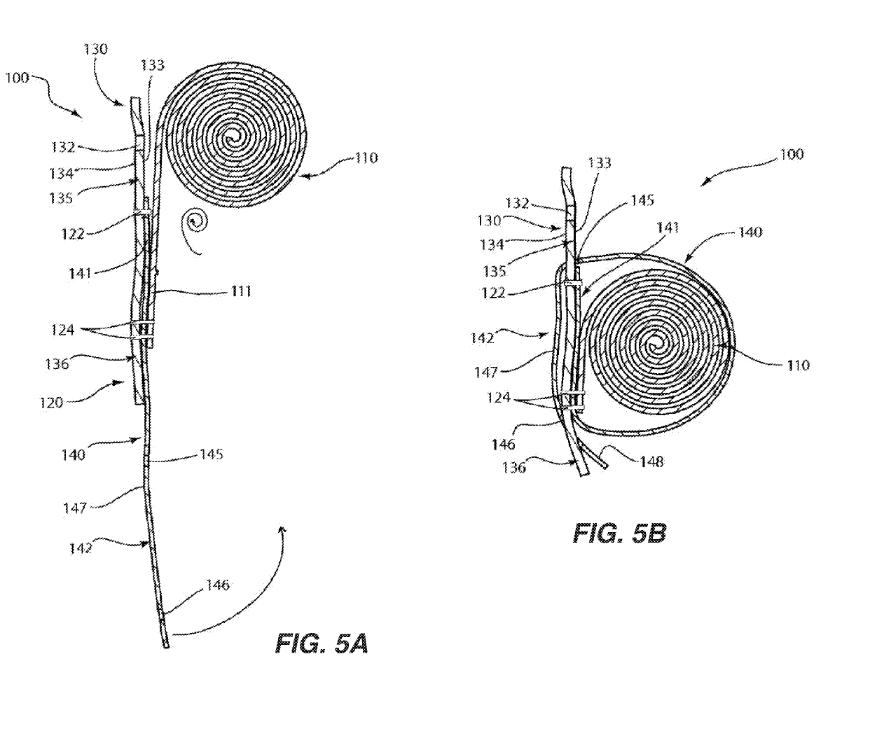

FIGS. 5A and 5B are cross-sectional views of airbag assembly 100, wherein FIG. 5A depicts the airbag assembly 100 before the inflatable curtain airbag 110 has been rolled and wrapped and FIG. 5B depicts the airbag assembly 100 in the stowed configuration. The mounting member 130 comprises front side 133, a back side 134, a top portion 135, which has mounting aperture 132, and bottom portion 136. The first segment 141 of the wrapper 140 may be coupled to the mounting member 130 via stitching 122 to form the mounting assembly 120. The second segment 142 of the wrapper 140 may extend below the rolled inflatable curtain airbag 110 and has the first opening 145 and the second opening 146. The portion 147 is located on second segment 142, between first and second openings 145 and 146. The upper portion 111 of the inflatable curtain airbag 110 may be coupled to the first segment 141 of the wrapper 140 via the stitching 124.

In the depiction of FIG. 5B, the airbag assembly 100 is in the stowed configuration. The wrapper 140 has been wrapped around the outer surface 115 of the rolled inflatable curtain airbag 110 (in the direction of the arrow depicted in FIG. 5A). The first opening 145 in the second segment 142 has been placed over the top portion 135 of the mounting member 130. The first opening 145 may receive part of the first segment 141 as well as the mounting member 130. The second opening 146 in the second segment 142 has been placed over the bottom portion 136 of the mounting member 130. As such, the first segment 141 of the wrapper 140 may be attached on the front side 133 of the mounting member 130; the portion 147, located between the openings 145 and 146 on the second segment 142 of wrapper 140, may be located on back side 134 of mounting member 130, and an end portion 148 of the second segment 142 may be located on the front side 133.

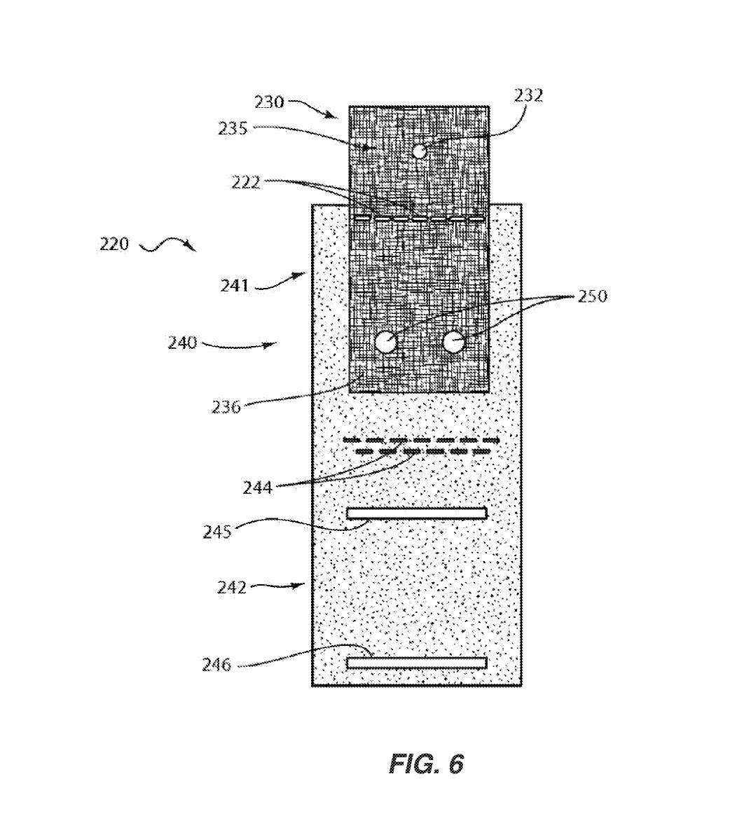

FIG. 6 depicts another embodiment of a mounting assembly 220 from a front elevation view. The mounting assembly 220 may be configured similarly and may function similarly to the mounting assembly 120, described herein. The mounting assembly 220 may comprise a mounting member 230 and a restraint member, which may take the form of a wrapper 240. The mounting member 230 may comprise a woven nylon fabric, such as seatbelt webbing, which is configured such that the mounting member 230 comprises a top portion 235 and a bottom portion 236. The top portion 235 may comprise one or more mounting apertures 232.

The wrapper 240 may comprises a material that is generally designed to withstand the stresses of airbag deployment. The wrapper 240 may have a first segment 241 and a second segment 242, wherein the first segment 241 is coupled to the mounting member 230 via stitching 222. The wrapper 240 may be configured to function similarly to the wrapper 140, described herein. As the wrapper 240 is formed of a material that is not selected to break during airbag deployment, a frangible portion 244 may be introduced into the wrapper 240 to permit emergence of the inflatable curtain airbag 110 during deployment. In the depicted embodiment, the frangible portion 244 comprises perforations; however, in other embodiments, the frangible portion 244 may comprise a tear seam or a weakened portion of the wrapper 240. The frangible portion 244 may be located at a predetermined position, such that during deployment, an inflatable curtain airbag 110 wrapped by the wrapper 240 will follow a predetermined deployment trajectory. The wrapper 240 has a first opening 245 and a second opening 246, wherein the first opening 245 receives the top portion 235 of the mounting member 230 and second opening 246 receives the bottom portion 236 of the mounting member 230, as described herein for openings 145 and 146.

The mounting assemblies disclosed herein may be attached to the airbag cushion at predetermined locations by employing a variety of mechanisms and/or techniques which are well known in the art. In one embodiment, the mounting assembly and airbag may be placed on a work table that has features that aid in placing the mounting assembly on the airbag at the predetermined location. The mounting assembly itself may comprise assembly aids, which allow the mounting assembly to be located at a predetermined location on the airbag. In one embodiment, the bottom portion 236 of the mounting member 230 and the first segment 241 of the wrapper 240 may comprise one or more assembly aids. In the depicted embodiment, the assembly aids comprise apertures 250. The apertures 250 are located in predetermined locations on the mounting member 230 and the wrapper 240 such that when the mounting member 230 and the wrapper 240 are properly aligned, the apertures 250 overlap. The apertures 250 may be employed in conjunction with a feature located on the inflatable airbag, such that the feature on the cushion may be viewed through the apertures when the mounting assembly 220 is correctly located on the cushion.

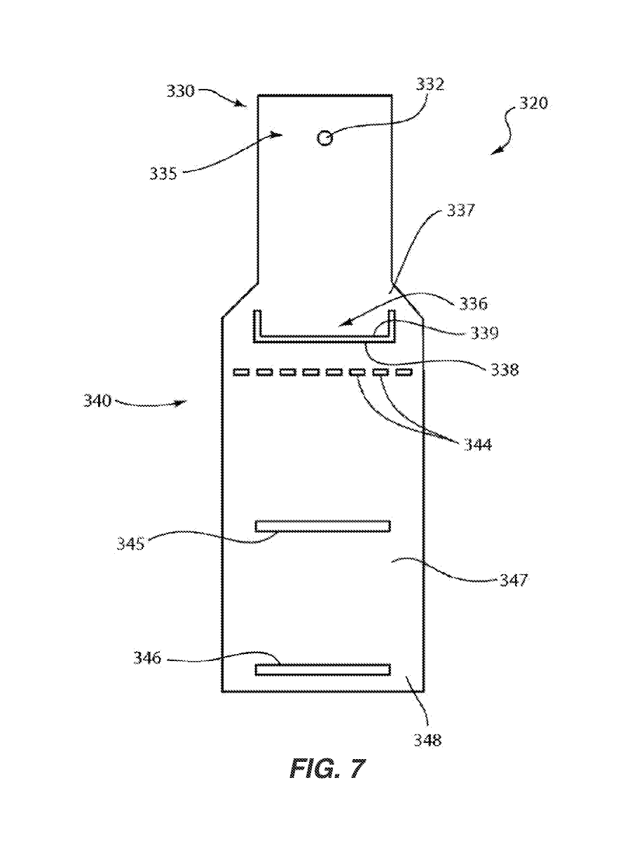

FIG. 7 is a front elevation view of another embodiment of an airbag mounting assembly 320, wherein the mounting assembly 320 comprises an integrated mounting member 330 and restraint member, which may take the form of a wrapper 340. The mounting assembly 320 may be called a one-piece mounting assembly. One skilled in the art will recognize that although the embodiment depicted in FIG. 7 is not an “assembly” of disparate parts, it is another embodiment of the mounting assemblies described herein. The mounting assembly 320 may also be called an integrated mounting member and wrapper; or an airbag mounting and wrapping unit. The mounting member portion 330 of the one-piece mounting member/wrapper 320 may comprise a mounting aperture 332 that is located on the top portion 335. The bottom portion 336 of the mounting member portion 330 may terminate in a slot 338 that defines a terminus 339 of the mounting member portion 330. The terminus 339 is configured to be received in the second opening 346 of wrapper portion 340 when the mounting assembly 320 is retaining an airbag in a stowed configuration. Shoulder portions 337 define contiguous extensions of the material from which the mounting assembly 320 is formed, wherein the shoulder portions 337 connect the mounting member portion 330 with the wrapper portion 340.

The wrapper portion 340 may be configured similarly and may function similarly to the wrappers 140 and 240, described herein. The wrapper portion 340 may comprise a first opening 345, a second opening 346, a portion 347 that is located between the first and second openings 345, 346, a frangible portion 344, and an end portion 348. The first opening 345, the second opening 346, the portion 347, and the frangible portion 344 may be configured similarly to the analogous structures described herein. The frangible portion 344 may comprise perforations that are located between the slot 338 and first opening 345. The end portion 348 may be configured similarly as analogous end portions, described herein; however, the end portion 348 may have a different orientation when in a stowed configuration compared to analogous end portions described herein.

The mounting assembly 320 may comprise multiple layers of material formed by folding a contiguous piece of material one or more times or by sewing disparate pieces of material together. This may help reinforce the mounting assembly 320 where strength is needed. In one embodiment, the multiple-layer portion extends from the top edge of the top portion 335 of the mounting member 330 to below the shoulder portions 337. In another embodiment, the multiple-layer portion extends below the slot 338 in the mounting member 330 portion. In another embodiment, the multiple-layer portion extends to a location just above the frangible portion 344, which may be located in a different location than depicted in FIG. 7.

One skilled in the art will recognize that a variety of configurations of one-piece mounting assemblies may be employed without diverging from the spirit of the present disclosure. For example, the mounting portion 330 may be any suitable shape, and is not restricted to the generally rectangular shape of the depicted embodiment. Also, the shoulder portions 337 may vary from the depicted embodiment; for example, the shoulder portions 337 may be rounded, or may comprise squared edges with substantially right angles. Further, in some embodiments, the shoulder portions 337 may not be present at all. For example, in one embodiment, the width of the mounting portion 330 is similar to the width of the wrapper portion 340, such that shoulder portions 337 are not apparent. In such an embodiment, the one-piece mounting assembly 320 may still comprise a flexible portion that is located adjacent to the slot.

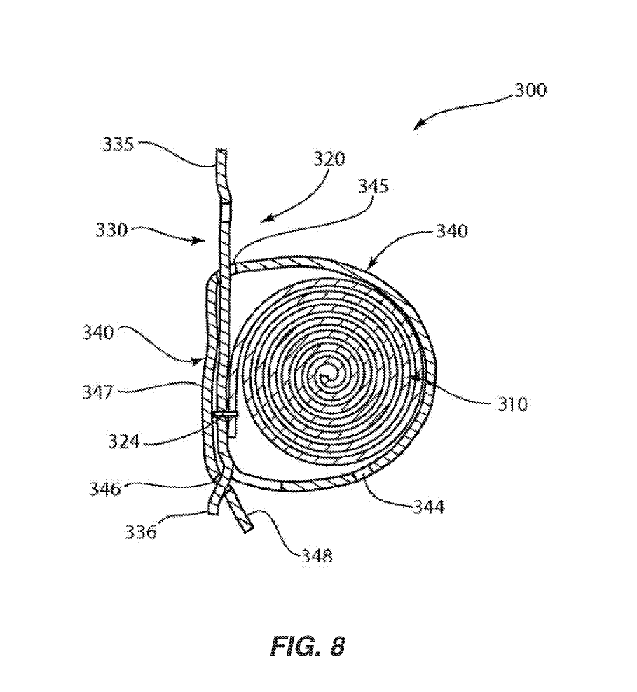

FIG. 8 is a cross-sectional view of the airbag mounting assembly 320 of FIG. 7, wherein the mounting assembly 320 is coupled to an inflatable curtain airbag 310 and is retaining the airbag 310 in a stowed configuration. In the depicted embodiment, the mounting assembly 320 is coupled to an inflatable curtain airbag 310 via stitching 324 such that the inflatable curtain airbag 310 and the mounting assembly 320 define an inflatable airbag assembly 300. The mounting member portion 330 comprises the top portion 335 and the bottom portion 336, which comprises a terminus 339. The wrapper portion 340 comprises the frangible portion 344, the first opening 345, the second opening 346, the portion 347 that is between the first and second openings, and the end portion 348. In the depiction of FIG. 8, the inflatable curtain airbag 310 is in a rolled configuration and is retained in the rolled configuration by the wrapper portion 340.

The wrapper portion 340 may be retained in a stowed configuration by the first opening 345 being placed over top portion 335 of the wrapper portion, and the second opening 346 being placed over bottom portion 336 of mounting member portion 330. The frangible portion 344 is located at a predetermined position such that during inflatable curtain airbag deployment, the frangible portion 344 aids in the inflatable curtain airbag 310 achieving a predetermined trajectory. As described herein, the mounting members and mounting member portions may comprise more than one layer of material, wherein the additional layers of material end before the wrapper or the shoulder portions of the one-piece mounting assembly. In the embodiment depicted in FIGS. 7-8, the wrapper portion 340 may flex or bend at the shoulder portion 337, as well as along the length of the wrapper portion 340.

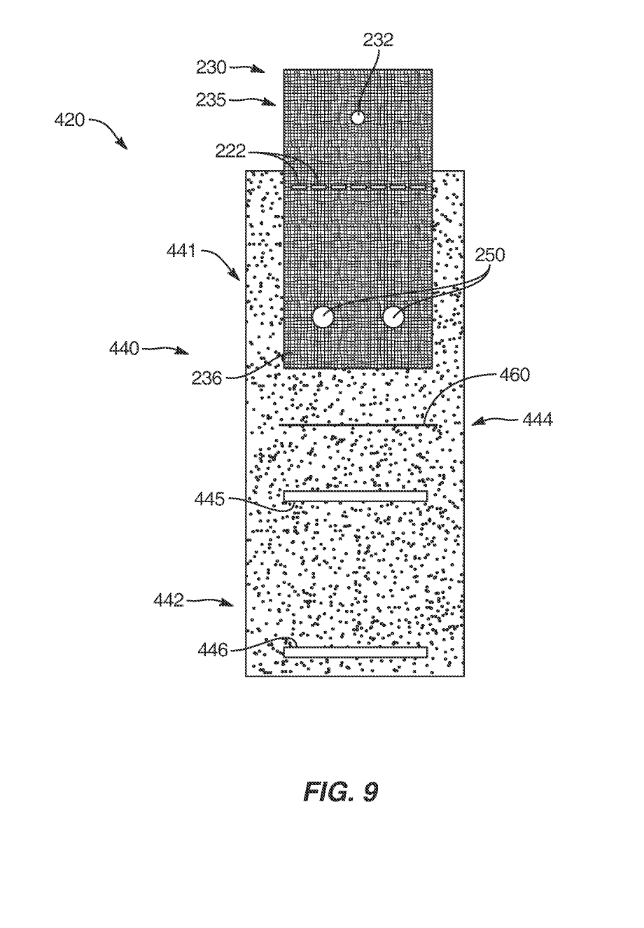

FIG. 9 illustrates a restraint member according to another alternative embodiment of the invention. The restraint member may comprise a wrapper 440 as shown. The wrapper 440 may be used with a mounting member such as the mounting member 230 of FIG. 6 to form a mounting assembly 420. The wrapper 440 may generally be similar to the wrapper 240, except that the wrapper 440 has a different mechanism for providing selective tearing during airbag deployment.

The wrapper 440 comprises a material that is generally designed to withstand the stresses of airbag deployment. The wrapper 440 may have a first segment 441 and a second segment 442, wherein the first segment 441 is coupled to a mounting member such as the mounting member 230 of FIG. 6 via stitching 222. The wrapper 440 may be configured to function similarly to the wrappers 140, 240, 340 described previously herein. A frangible portion 444 may be introduced into the wrapper 440 to permit emergence of the inflatable curtain airbag 110 during deployment. The frangible portion 444 may be located at a predetermined position, such that during deployment, an airbag such as the inflatable curtain airbag 110 wrapped by the wrapper 440 will follow a predetermined deployment trajectory. The frangible portion 444 may have a generally linear shape; i.e., the frangible portion 444 may be arranged in a generally straight line. The frangible portion 444 may also be relatively narrow in height (the vertical direction as viewed in FIG. 9) to provide a high degree of predictability as to exactly where the wrapper 440 will tear during deployment.

The wrapper 440 may further have a first opening 445 and a second opening 446. The first opening 445 may receive, for example, the top portion 235 of the mounting member 230 and the second opening 446 may receive the bottom portion 236 of the mounting member 230, as described herein for openings 145 and 146.

In the depicted embodiment, the frangible portion 444 comprises a region in which the material of the wrapper 440 has been “pre-stressed,” i.e., subjected to stresses in excess of those that have been applied to the surrounding regions of the wrapper 440, i.e., the portions of the wrapper 440 outside the frangible portion 444. Pre-stressing may, according to one embodiment, involve the application of tensile stresses, although compressive or shear stresses may, additionally or alternatively, be applied. A pre-stressed material may exhibit susceptibility to re-application of stresses, and may thus fail at a lower stress than material that has not been pre-stressed. Through the careful selection of how much pre-stressing is applied, the frangible portion 444 can be made to tear at a predetermined stress level. The predetermined stress level may be high enough to ensure that the wrapper 440 remains sound through the manufacturing and installation processes, and through the operation of the vehicle, but low enough that the corresponding airbag (such as the inflatable curtain airbag 110 described previously) can reliably tear the frangible portion 444 during deployment.

In the embodiment of FIG. 9, the frangible portion 444 may include a crease 460. A “crease” is a region in which a length material has been folded to define an angle smaller than 180°. A crease may optionally be a much smaller angle, and may approach 0° depending on the thickness of the material. In addition to folding, a crease may be further defined by applying stress, and in particular compression, to the vertex formed by the crease 460.

The level of stress applied to the crease 460 is generally inversely proportional to the angle at which the material is folded; thus, a smaller angle results in a greater amount of stress. Further, the level of stress is generally proportional to the thickness of the material. A thicker material will typically be subject to higher stresses when creased due to the larger bending moments applied. Further, the higher the stresses applied to the fold, the more pre-stressing will occur. Generally, more pre-stressing leads to a lower failure point, i.e., a lower degree of stress the material will tolerate prior to plastic deformation and/or breakage.

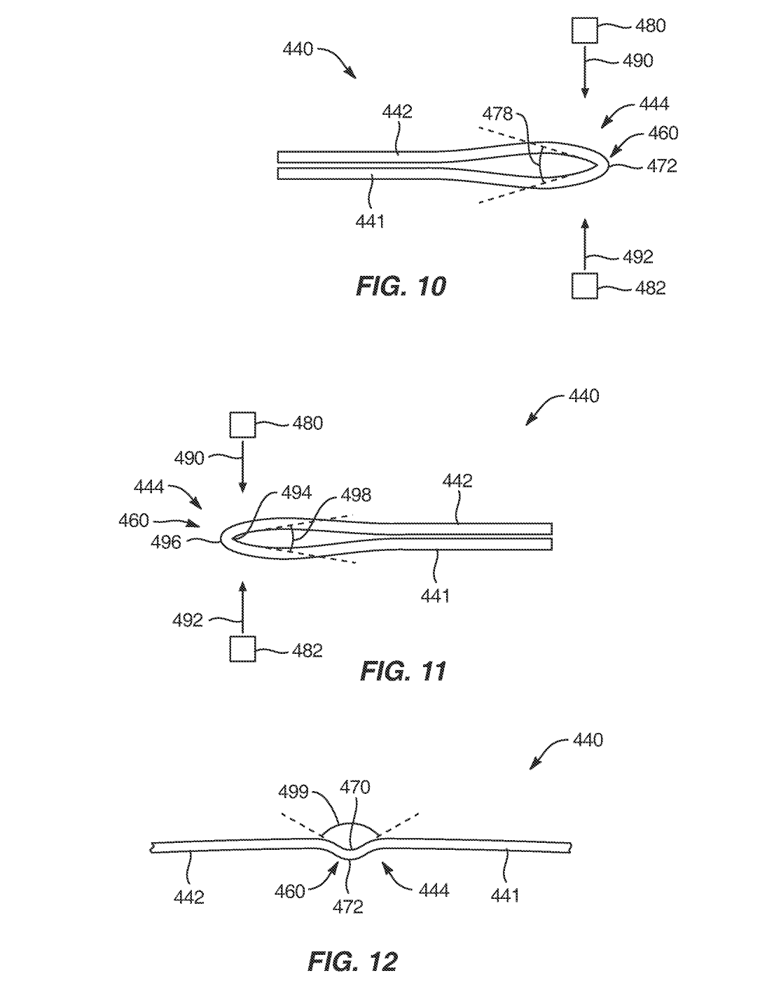

FIG. 10 illustrates one method of forming the crease 460. The wrapper 440 may first be folded such that the first and second segments 441, 442 lie adjacent to each other as shown. The resulting fold has an interior surface 470 at which the adjoining portions of the first and second segments 441, 442 face each other, and an exterior surface 472 at which the first and second segments 441, 442 face outward. The interior surface 470 defines an angle 478 between the first and second segments 441, 442 at which the folded wrapper 440 rests after the fold has taken place. The angle 478 may be close to 0°, and may thus be somewhat exaggerated in FIG. 10 for clarity. The folding process may entail application of compression to the first and second segments 441, 442, tending to press the first and second segments 441, 442 together. This compression, alone, may be sufficient, and if desired, the first and second segments 441, 442 may be unfolded and the crease 460 may be deemed complete.

In the alternative, additional compression may be applied to further pre-stress the frangible portion 444. Thus, a first compressing element 480 and a second compressing element 482 may be pressed together, in the first and second directions 490, 492, respectively, to contact the portions of the second and first halves 442, 441, respectively, that lie adjacent to the fold. A controlled amount of pressure may be applied to obtain the desired pre-stress level, and hence, the desired failure stress level of the crease 460. The resulting angle between the first and second segments 441, 442 can be expected to be less than the angle 478.

The first and second compressing elements 480, 482 may be any of a variety of structures known in the art for applying compression along a thin segment of material. Thus, the first and second compressing elements 480, 482 may be dies within a press or other compressive machine, rollers, or the like. Rollers may provide a higher degree of localized stress. If desired, the first and second compressing elements 480, 482 may be parts of a die or other machine used to carry out the folding process. One of the compressing elements 480, 482 may be stationary, and may thus be a stationary die, a fixture such as a ridge on a work table, or the like. Heat may be applied if desired to promote further deformation of the material. In any case, the result of the compression step may be that the material proximate the exterior surface 472 is placed under tension, and the material proximate the interior surface 470 is placed under compression.

Again, the crease 460 may be deemed complete, and the process may optionally be stopped at this point. Alternatively, more compression may be applied. If desired, this may be carried out with the wrapper 440 unfolded and then folded again as will be shown in connection with FIG. 11. This may be done with or without applying compressive stress with the compressing elements 480, 482.

Referring to FIG. 11, the wrapper 440 has been unfolded from the configuration of FIG. 10 and folded again in the opposite direction. The result is that the exterior surface 472 of FIG. 10 has become an interior surface 494, and the interior surface 470 of FIG. 10 has become an exterior surface 496. The stress pattern may now be reversed such that the material proximate the interior surface 494 is now under compression and the material proximate the exterior surface 496 is now under tension. The interior surface 494 defines an angle 498 that may be smaller than the angle 478 of FIG. 10 due to the intervening application of further material stress, and potentially, plastic deformation. Again, compressive stress may be applied with compressing elements 480 and 482, which move in the first and second directions 490, 492, respectively. As with the compressing step disclosed in connection with FIG. 10, the compressing step of FIG. 11 may further pre-stress the frangible portion 444, and may thus provide a more defined and more easily torn crease 460.

Referring to FIG. 12, after termination of the folding and/or compressing steps, the crease 460 may be deemed complete and the wrapper 440 may be unfolded and allowed to lie flat, for example, on a hard, flat surface. If the second folding step of FIG. 11 has not been carried out, the interior surface 470 may be at a slightly acute angle, or have a slightly concave profile. Similarly, the exterior surface 472 may be at a slightly obtuse angle, or have a slightly convex profile. The interior surface 470 may now define a resting angle 499 that is much greater than the angle 478 of FIG. 10, but less than 180°. The material of the crease 460 has been significantly pre-stressed, and therefore may be significantly weaker than the surrounding material.

Formation of the crease 460 is only one of several ways to pre-stress a flexible material. A variety of tools and procedures may be used to accomplish this. For example, according to one method, a wrapper (not shown) may be gripped on either side of its frangible portion and pulled apart so that tension is applied only between the gripped portions, i.e., across the frangible portion.

The gripped portions may alternatively or additionally be pulled out-of-plane relative to each other to induce shear forces in addition to the tension, i.e., by pulling one segment of the wrapper lower than the other. If the gripped portions are very close together, the effect may be the development of shear stress in the frangible portion that exceeds the tensile force applied. If desired, the stresses may be reversed, i.e., by moving the segment of the wrapper that was previously pulled lower than the other to a position higher than the other segment. The result is that the frangible portion has been pre-stressed and is therefore weaker than the surrounding material. The frangible portion may have a crease after such an operation if shear forces have been applied, but may not have a crease if only tension has been applied such that the two segments of the wrapper have been kept in-plane during the pre-stressing process.

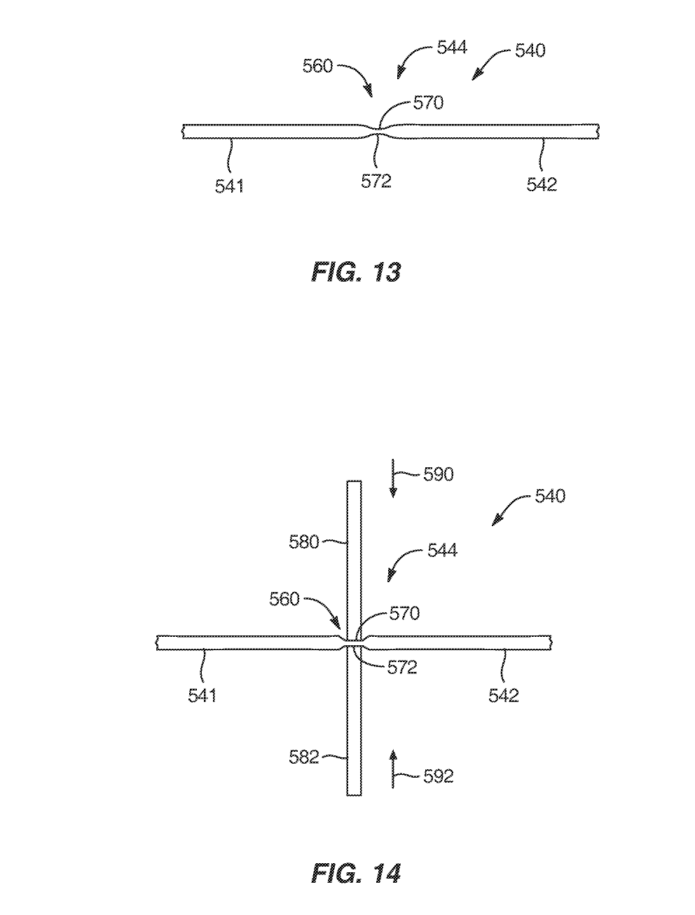

According to another pre-stressing process, compressive force may be applied to a frangible portion to provide the desired level of pre-stressing. This may be done in place of creasing, or in addition to it, for example, by creasing the material, unfolding it, and then applying the compressive stress. The resulting wrapper is illustrated in FIG. 13.

FIG. 13 illustrates a wrapper 540 according to an alternative embodiment of the invention. The wrapper 540 has a first segment 541 and a second segment 542 that are separated by a frangible portion 544 at which the material of the wrapper 540 has been pre-stressed to an extent greater than that of the surrounding regions of material. The pre-stressing has been carried out by compressing the frangible portion 544, i.e., by pressing the material on either side of the wrapper 540 together along a relatively narrow area to form a thin section 560 of the frangible portion 544. The thin section 560 may have a first side 570 and a second side 572, each of which, when viewed along the length of the thin section 560 as in FIG. 13, has a generally acute angle or a concave shape.

FIG. 14 illustrates one method of forming the frangible portion 544 of the wrapper 540. As shown, first and second compressing elements 580, 582 may be pressed against the corresponding sides of the material of the frangible portion 544 along first and second directions 590, 592, respectively, to produce the thin section 560. As with the compressing elements 480, 482, the compressing elements 580, 582 may take a variety of forms including any combination of fixed, translating, or rotating parts that provide the desired level of compression in the material of the frangible portion 560. If desired, the compressing elements 580, 582 may be offset from each other, e.g., by moving either of the compressing elements 580, 582 to the left or right, relative to the viewpoint of FIG. 14. Again, the level of compressive force applied is tuned to produce the desired level of pre-stressing. More pre-stressing will cause the thin section 560 to tear at a lower level of tension.

A variety of other methods may be used to pre-stress a material. Other forms of mechanical stress may be applied, with any combination of tension, compression, and/or shear. The speed at which such forces are applied may be varied. Thus, according to one example, compressing elements such as the compressing elements 580, 582 may suddenly be driven toward the material so that the resulting stresses are impact stresses. Impact stresses may have a different effect on material strength than stresses occurring over time. Additionally or alternatively, the stress pattern may be repeated and/or repeated in reverse to provide a fatigue load.

Additionally or alternatively to the foregoing, the material of a frangible portion may be treated chemically, subjected to high temperatures, subjected to low temperatures, exposed to electromagnetic radiation, vibrated, mechanically fatigued, or otherwise processed to provide the desired level of pre-stressing. Such processes may be used to modify the material characteristics so that, when mechanical stress is applied, the desired effect is achieved. For example, cooling may be applied to increase the brittleness and/or decrease the impact resistance of a material prior to application of mechanical stress to amplify the effect of the pre-stressing on the stress level required to induce tearing of the material.

As another alternative, pre-stressing of material may be combined with the use of perforations, slits, or other voids to help control the stress level required to induce tearing and/or the location where tearing occurs. For example, returning to the embodiment of FIG. 6, in addition to the perforations shown in the frangible portion 244, pre-stressing may be applied to the material proximate the perforations to weaken the material between and/or around the perforations to form a wrapper (not shown) according to another alternative embodiment. Thus, in addition to having a lower combined cross sectional area to bear stress, the frangible portion 244 may be composed of material that is generally weaker than the surrounding material due to the pre-stressing. Stress concentrations may also be present due to the presence of the perforations; the stress risers may help provide a predictable origin for tear propagation through the material. In the alternative to perforations, one or more larger holes such as slits may be used. It may be expected that the material will tear through the one or more holes. Again, a more predictable failure location may be provided by the one or more holes.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, Figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. Elements recited in means-plus-function format are intended to be construed in accordance with 35 U.S.C. §112 Para. 6. It will be apparent to those having skill in the art that changes may be made to the details of the above-described embodiments without departing from the underlying principles of the invention. Embodiments of the invention in which an exclusive property or privilege is claimed are defined as follows.

As will be appreciated by those skilled in the art, a variety of types and configurations of inflatable curtain airbag wrappers can be utilized without departing from the scope and spirit of the present disclosure. For example, the size, shape, and proportions of the wrapper may vary according to its use in different vehicles or different locations within a vehicle such that the airbag may comprise an inflatable curtain cushion, a rear passenger side airbag, a driver's airbag, and/or a front passenger airbag. Also, the airbag may comprise one or more of any material well known in the art, such as a woven nylon fabric, which may be coated with a substance, such as silicone or a polymer. Additionally, the airbag cushion may be manufactured using a variety of techniques such as one piece weaving, cut and sew, or a combination of the two techniques. Further, the cushion membrane may be manufactured using sealed or unsealed seams, wherein the seams are formed by stitching, adhesive, taping, radio frequency welding, heat sealing, or any other suitable technique or combination of techniques.

The principles of the present invention are not limited to wrappers for inflatable curtains, but may be used for a variety of devices. The non-perforated frangible portions of the present invention may be particularly applicable to applications in which a material is to break at a pre-determined level of tension. In the automotive safety arts, such a frangible portion may have application to airbag wrappers, sleeves, or other covers, to trim modules or panels designed to cover the airbag elements, or to seat belts.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. An airbag assembly, comprising:
an inflatable airbag having a stowed configuration and a deployed configuration into which the inflatable airbag deploys from the stowed configuration to protect vehicle occupants from injury, the inflatable airbag comprising a first interior chamber; and
a restraint member coupled to the inflatable airbag in the stowed configuration to keep the inflatable airbag in the stowed configuration until deployment, wherein the restraint member is formed of a flexible material comprising a frangible portion that tears in response to application of a threshold level of tension on the frangible portion to release the inflatable airbag during deployment;
wherein the frangible portion comprises pre-stressed material having a lower strength than surrounding regions of the restraint member.

2. The airbag assembly of claim 1, wherein the frangible portion comprises a narrow, generally linear shape.

3. The airbag assembly of claim 2, wherein the frangible portion comprises a crease formed by folding the restraint member at the frangible portion.

4. The airbag assembly of claim 1, wherein the inflatable airbag comprises an inflatable curtain airbag that deploys along a side of a vehicle between a vehicle occupant and at least one side structure of the vehicle; wherein the restraint member comprises a wrapper that encircles the inflatable curtain airbag in the stowed configuration to keep the inflatable curtain airbag in the stowed configuration until deployment.

5. The airbag assembly of claim 4, further comprising a plurality of additional restraint members arranged with the restraint member along a length of the inflatable curtain airbag, wherein each of the additional restraint members encircles the inflatable curtain airbag in the stowed configuration to keep the inflatable curtain airbag in the stowed configuration until deployment.

6. The airbag assembly of claim 1, wherein the frangible portion is not significantly more perforated than the surrounding regions.

7. The airbag assembly of claim 1, wherein the frangible portion further comprises at least one hole proximate the pre-stressed material such that the frangible portion tears through the hole in response to application of the threshold level of tension.

8. The airbag assembly of claim 1, wherein the frangible portion comprises a thin section thinner than the surrounding regions due to prior application of compressive stress to the thin section.

9. The airbag assembly of claim 1, wherein the restraint member is formed from a fabric material.

10. The airbag assembly of claim 1, further comprising an inflator that produces gas in response to detection of impact to trigger deployment of the inflatable airbag.

11. A method for manufacturing an airbag assembly, the method comprising:
providing an inflatable airbag comprising a first interior chamber, the inflatable airbag having a stowed configuration and a deployed configuration into which the inflatable airbag deploys from the stowed configuration to protect vehicle occupants from injury;
compacting the inflatable airbag into the stowed configuration;
providing a restraint member;
forming a frangible portion on the restraint member that tears in response to application of a threshold level of tension to release the inflatable airbag during deployment of the inflatable airbag; and
coupling the restraint member to the inflatable airbag to keep the inflatable airbag in the stowed configuration until deployment;
wherein forming the frangible portion comprises pre-stressing the restraint member to form pre-stressed material having a lower strength than surrounding regions of the restraint member.

12. The method of claim 11, wherein pre-stressing the restraint member comprises folding the restraint member to form a crease.

13. The method of claim 12, wherein pre-stressing the restraint member further comprises compressing the restraint member proximate the crease to further pre-stress the crease.

14. The method of claim 11, wherein pre-stressing the restraint member comprises compressing the restraint member to form a thin section thinner than the surrounding regions.

15. The method of claim 14, wherein providing the inflatable airbag comprises providing an inflatable curtain airbag that deploys along a side of a vehicle between a vehicle occupant and at least one side structure of the vehicle, wherein providing the restraint member comprises providing a wrapper, wherein coupling the restraint member to the inflatable airbag comprises encircling the inflatable airbag with the restraint member to keep the inflatable curtain airbag in the stowed configuration until deployment, the method further comprising:
providing a plurality of additional restraint members;
arranging the plurality of additional restraint members with the restraint member along a length of the inflatable curtain airbag; and
encircling the inflatable curtain airbag with each of the additional restraint members to further keep the inflatable curtain airbag in the stowed configuration until deployment.

16. The method of claim 11, wherein providing the restraint member comprises forming the restraint member of a fabric material.

17. The method of claim 11, wherein the forming the frangible portion further comprises forming at least one hole proximate the pre-stressed material such that the frangible portion tears through the hole in response to application of the threshold level of tension.

18. The method of claim 11, wherein forming the frangible portion is carried out substantially independently of any process by which the frangible portion is perforated more than the surrounding regions.

19. The method of claim 11, further comprising:
providing an inflator that produces gas in response to detection of impact; and
connecting the inflator to the inflatable airbag such that gas produced by the inflator inflates the inflatable airbag.

20. An airbag assembly, comprising:
an inflatable curtain airbag having a stowed configuration and a deployed configuration into which the inflatable curtain airbag deploys from the stowed configuration, wherein the inflatable curtain airbag deploys along a side of a vehicle between a vehicle occupant and at least one side structure of the vehicle to protect vehicle occupants, the inflatable curtain airbag comprising a first interior chamber;
a plurality of restraint members wrapped around the inflatable curtain airbag in the stowed configuration to keep the inflatable curtain airbag in the stowed configuration until deployment, wherein each of the restraint members is formed of a fabric material comprising a frangible portion that tears in response to application of a threshold level of tension on the frangible portion to release the inflatable airbag during deployment; and
an inflator that produces gas in response to detection of impact, wherein the inflator is connected in fluid communication with the first interior chamber to trigger deployment of the inflatable curtain airbag;
wherein each of the frangible portions comprises a crease formed by folding the restraint member at the frangible portion and applying compression to the restraint member at the frangible portion.
